(19) United States
(12) Patent Application Publication
(10) Pub. No.: US 2011/0218861 A1
(43) Pub. Date: Sep. 8, 2011

(54) Transform for Display of Advertisements on a Variety of Different Mobile Handheld Devices

(76) Inventors: Lionel V. PELAMOURGUES, Mountain View, CA (US); Srinivassa Dharmaji, Cupertino, CA (US)

(21) Appl. No.: 12/719,500

(22) Filed: Mar. 8, 2010

(51) Int. Cl. G06Q 30/00

(52) U.S. Cl. 705/14.64

(57) ABSTRACT

Elements and object types of any advertisement are transformed to a predefined intermediate format, thus enabling conversion to any of a plurality of mobile handheld device (MHD) displays. This achieves load reduction by enabling one time development of a transform for each element and object type from the predefined format to each different MHD display.

### BACKGROUND OF THE INVENTION

1. Technical Field

The invention relates to the efficient transformation of video advertisements in connection with rendering and display of such video advertisements on mobile handheld devices (MHDs), where the MHDs have differing display unit characteristics. More particularly, the invention relates to the standardization of optimized transformation of the elements and objects that are used to compose an advertisement to suit the characteristics of a plurality of displays that are used in various MHDs.

2. Description of the Prior Art

Because agencies and marketers are now able to connect to mobile handheld devices (MHDs), advertising to MHDs is a way to reach people directly, even if they are on the move. Mobile phones and personal digital assistants are examples of MHDs which provide a precisely targeted communication channel. This means that such communications channel delivers excellent campaign effectiveness and response levels, when it is compared to other media.

There are multiple channels available through which and advertiser can reach the mobile consumer, such as mobile Web sites, mobile applications, mobile messaging, and mobile video. All of these channels can be integrated into an interactive campaign. The various ways in which a consumer interacts with such campaign include, for example, click to call, click to locate, click to buy, click to video, click to download content, click to vote, etc.

Mobile phones have a broad range of different form factors, screen sizes, and resolutions. These factors present a challenge for the display and optimal viewing of the content and advertising.

Many mobile advertisements (ads) comprise small banners and/or text links that share a display that the user has selected. The types of mobile ads can range from simple text links to interactive software programs. For purposes of the discussion herein, the terms “advertising unit” and “ad unit” mean an electronic advertisement that can be viewed using a computer display or other display device in communication with a processor or network. Ad units (ADUs) can include, for example, banner ads, floating ads, expanding ads, pop-ups, pop-unders, alternate multimedia content, and videos. A complete ad may comprise many ad units that are combined to deliver a message.

In a mobile adverting system, a company the wishes to advertise through such medium creates and submits an ad to a mobile advertising network and selects a location, time, and category as the ad promotion criteria. The mobile ad network submits these ads to multiple mobile networks and keeps track of the transmission, selection, and response to these ads. The mobile system operators review the capabilities of the mobile devices in their network to determine which devices can receive and respond to mobile ads.

MHDs, including mobile phones with displays, are becoming increasingly sophisticated and can include, for example, high-resolution screens, sophisticated mobile Web browsers, and high-speed access. All of these features allow for the presentation of high-quality and media-rich mobile Web ad banners. Network and back-office technology identify mobile phone models, browser characteristics, screen sizes, and screen resolutions to serve mobile ads that are optimized to match the capabilities of each mobile phone. To accommodate the wide range of mobile phone characteristics, advertisers are required to produce and provide their ads in various predefined dimensions.

Today, the ads served are selected from this set of predefined sizes based on the particular mobile phone model's capabilities and according to a best-fit principle.

If the artwork is to be delivered directly to consumers, it should be made available in a format that includes all of the elements that the consumers' phones can support. Most phones can support the “joint photographic experts group” format (JPEG) and “graphics interchange format” (GIF). High-end mobile phones also support “portable network graphics” (PNG), while legacy phones generally support the “wireless bitmap application protocol” format (WBMP).

Due to the need to support a large number of different MHDs having differing input needs, form factor, and other display characteristics, advertisers today choose to transform their ads only to suit those MHDs that have high volumes of users. This still leaves a large segment of users without exposure to lucrative ads. This amounts to a significant loss of revenue for the advertiser.

Each ad is typically composed of multiple ad units with background, video, and objects linked for action. The objects and elements comprise text, pictures, buttons, banners, etc. Position and size are also attributes to be considered. The ad and the ad unit size must match with the form factor of the MHD display screen to allow the user to view the ad properly and interact with ad as needed. Thus, it is important to convey maximum information in the most readable and communicable form on the MHD display screen. Objects, elements, and backgrounds must be optimized to fit the characteristics of the MHD display screen. Hence, each ad unit must be fit to the viewing/display terminal to which it is targeted. Each ad, with its units, must transformed in a suitable way to ensure that the message of the ad is not lost in the transformation process. The transformation is not a simple process of scaling all objects and elements, but depends upon transforming the objects and elements, as well as the characteristics of the MHD, i.e. size of font, size of screen, aspect ratio of screen, size of response buttons on screen, size and action of banners presented, etc. This is due to the fact that scaling an ad made for computer screen to fit a small MHD screen, such as a cell phone screen, without consideration of characteristics of individual elements and objects results in some of the objects and elements becoming useless. For example, if an ad is shrunk from a computer size to a cell phone display size without consideration of characteristics of individual objects, the buttons and pop-ups, etc. can become small, indistinguishable, and useless.

FIG. 1 shows a system that is used for the conversion of ads to specific MHD displays, as is known in the art. If N is the number of ads, and each ad with P number of elements is to be displayed on M handheld devices, then the total number of transforms T required to transform all elements and objects to suit each handheld devices' characteristics is:

T=N×P×M

In FIG. 1, the ads 101, 102, and 103 each have three dissimilar elements and also have objects 121a to 123a for ad 101, 121b to 123b for ad 102, and 121c to 123c for ad 103. These elements and objects are each converted by transformation to fit five handheld devices 111 to 115. For example, each element or object 121a, 122a, and 123a comprising the ad 101, is individually transformed to fit the characteristics of the handheld device 111. Each ad, e.g. ad 101, with three individual elements or objects 121a, 122a, and 123a must be transformed to the handheld device 111 via the transformation A1, 112 via A2, and so on. Hence, the total number of transforms needed to transform the three ads (N=3) with three elements each (P=3) or objects to five handheld devices (M=5) is:

3×3×5=45 transforms.

To provide good coverage of the population, there is a need to create ads for all MHDs with different characteristics, capabilities, and display sizes. However, having all elements and objects of the ad capable of display on multiple MHDs is a very time consuming and difficult step. It is also very expensive to provide the transformation to cover all major MHD types, if not all MHDs. It would hence be ideal if a simpler standardized process can be established to reduce the effort and cost necessary to generate and transform customer generated ads, that is, ad elements and objects, to enable display on such a multitude of formats, aspect ratios and sizes of available displays on MHDs.

### SUMMARY OF THE INVENTION

An embodiment of the invention provides a technique by which advertisements are delivered directly to targeted users of mobile phones and personal digital assistants (MHDs).

Targeted advertisements are created for the display of advertising on such MHDs to enable advertisements to be delivered directly to such targeted users. Targeted advertisements are created for advertising on the displays of such MHDs, even though each mobile MHD has unique display characteristics and aspect ratios. Typically, any advertisement created for one MHD cannot be directly ported for display in a different aspect ratio on a different MHD. This problem results from need to change and transform elements and object types within a created advertisement to display it correctly on different types of displays.

An embodiment of the invention provides a technique that transforms the elements and object types of any advertisement to a predefined intermediate format, thus enabling conversion to any of a plurality of displays. This achieves load reduction by enabling one time development of a transform for each element and object type from the predefined format to each different MHD display.

### BRIEF DESCRIPTION OF THE DRAWINGS

FIG. 1 shows a typical transformation process currently used for the elements and objects of an ad for display on multiple handheld displays;

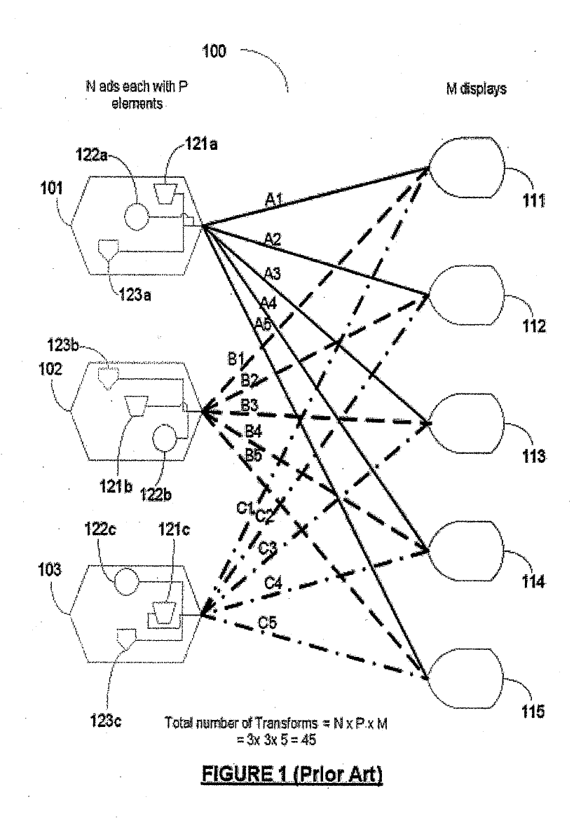

FIG. 2 shows a standardized transform process according to the invention;

FIG. 3 is a flow diagram showing ad transformation to a reference screen of a standardized platform according to the invention; and

FIG. 4 is a flow diagram showing ad transformation from a reference display of the standardized platform to a handheld device according to the invention.

### DETAILED DESCRIPTION OF THE INVENTION

An embodiment of the invention provides a technique by which advertisements are delivered directly to targeted users of mobile phones and personal digital assistants (MHDs).

Targeted advertisements are created for the display of advertising on such MHDs to enable advertisements to be delivered directly to such targeted users. Targeted advertisements are created for advertising on the displays of such MHDs, even though each mobile MHD has unique display characteristics and aspect ratios. Typically, any advertisement created for one MHD cannot be directly ported for display in a different aspect ratio on a different MHD. This problem results from need to change and transform elements and object types within a created advertisement to display it correctly on different types of displays.

An embodiment of the invention provides a technique that transforms the elements and object types of any advertisement to a predefined intermediate format, thus enabling conversion to any of a plurality of displays. This achieves load reduction by enabling one time development of a transform for each element and object type from the predefined format to each different MHD display.

Accordingly, the invention reduces the effort and cost of conversion of each ad to suit the characteristics of each MHD in which the ad may be displayed. In the optimum case the original ad, with all ad units, is built on a reference display screen of a standardized ad development platform (SADP) with standardized reference characteristics and element characteristics. Hence, each of the objects and elements used has associated within the reference characteristic properties. Once the standardized reference display screen of the SADP is used for displaying an ad with all necessary elements and objects, such as size, resolution, button size, font size, etc. the ad becomes a basis standard from which to transform the objects to display the ad correctly on different MHD displays.

In cases where an ad is developed in a non-standard format using a third party ad development platform (ADP), it is a one-time job to transform the ad elements and objects to the standardized format. The ad is then suitable for display on the reference display screen of the SADP. It is then possible to transform the ad to all the other formats for display on the chosen MHD display screens.

In an embodiment, a conversion scheme for each standardized reference characteristics and element characteristics is generated once and stored. This provides for an easy and simplified conversion or transform from the standard ad format on the reference screen of the SADP into the formats necessary for individual MHD displays. The stored information comprises of all the possible elements that can be transformed and their standard transformation criteria for each MHD to which the ad is to be transformed. A set of transforms is hence in storage for use with any developed ad that has to be transformed for display on any MHD. That is, a display transform capability profile for each MHD is in storage and available for use as needed.

The profile is created by mapping each characteristic of the reference screen of an SADP to a characteristic of the MHD display, e.g. size, length, resolution, font size, button size, etc. For each targeted MHD display, the mapping of all possible elements is performed from the reference display of the SADP. This allows the equivalent of a single transform, combining all elements and objects of the ad, to be performed for any ad on the SADP to each MHD to display the ad correctly on that MHD display.

Thus, to convert each ad from the reference screen to M MHDs, only M transforms are needed because all element and object transforms are predefined. If N ads having P elements are transformed for M MHDs, and all of the N ads have pre-converted basic reference element characteristics, then the number of transformations is M×N.

The first step in this scheme is to produce the standardization transformation operation from the standardized ad development platform. Accordingly, each new ad with all of its ad units can be automatically transformed with minimum additional effort once the standardized platform has the element transforms in place. The transforms are those that needed to transform the N ads developed on the standardized ad development platform, plus the one-time pre-developed transformation of the elements and objects from the reference screen of the standardized ad development platform to the MHDs to provide accurate ad displays on each of the MHD displays.

In the case where the ad is not developed in the standardized ad format, it is necessary to perform a conversion or transformation of the ad to the standardized format. This can add an additional effort to transform each of the elements from the ad into the reference screen of the standardized ad development platform. As conversion of the N ads with P elements to a single reference display is performed, the number of transformations is N×P. This means that there is an additional single transformation from the standard development platform to the M MHDs, creating a total number of transforms of N×M. Hence, the total number of transforms for N ads with P elements made on individual non-standard platforms to the M MHDs equals:

N×(P+M).

The transformation is done in two steps:
1. Mapping the look and feel of the ad, from the reference screen to the MHD; and
2. Encoding differences in standards between the reference display screen and the MHD display.

For example, if the MHD accepts image characteristics in only the .mgm format, while the reference is in the .png format, an encoding is required to transform from the standard reference to the specific MHD characteristic. Similarly, if the font used in the reference display screen is different from that which is acceptable to the MHD, encoding is necessary. All of these differences are taken care of automatically once the MHD characteristics are known and the standard is established.

This use of standardization with limited encoding reduces the load on the transformation effort and the cost associated with such transformation. The complexities of transform are reduced and improved efficiency is achieved by addressing the ad with the ad units at the object level. This ease of implementation and improved efficiency enable the transformation and display of ads across a large number of different MHDs. When new MHDs are introduced, the characteristics of these for object level transfer, with or without additional encoding, are easily added and stored, and the MHD type is added to the standardized listing of applicable MHDs.

In an embodiment of the invention, this transformation is implemented as a dedicated standalone system. It is also implemented as a part of standard computer and control system within a broadcasting system to provide wide coverage for ads in the mobile environment.

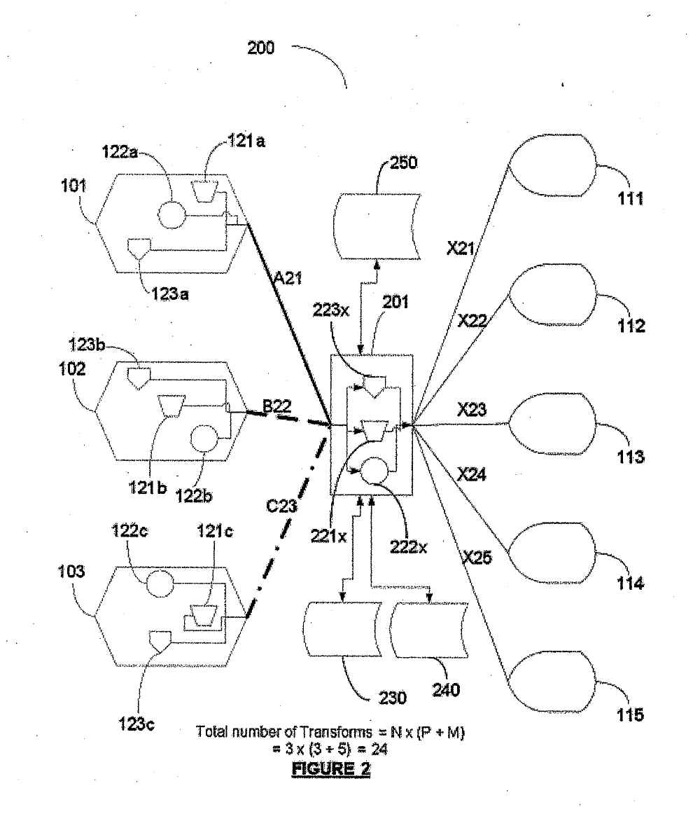

FIG. 2 is a block diagram 200 of an ad transformation system that converts the ads 101, 102, and 103 to the reference screen on a standardized ad development platform 201, and from the platform 201 to five MHDs 111, 112, 113, 114, and 115. Each of the three ads has three elements. Ad 101 has elements 121a, 122a, and 123a, ad 102 has elements 121b, 122b, and 123b, and ad 103 has elements 121c, 122c, and 123c, respectively.

A first level of transformation transforms each of the ads 101, 102, and 103 into the generic ad format of the reference display of the SADP 201. Elements 121a, 121b, and 121c of the ad 101 are transformed, as shown by the link A21, to the reference display as corresponding elements 221x, 222x, and 223x. The transformed ads are stored in a storage medium 230. Similarly, the elements of ad 102 are transformed, as shown by the link B22, and the elements of ad 103 are transformed, as shown by link C23, and stored in the storage medium 230.

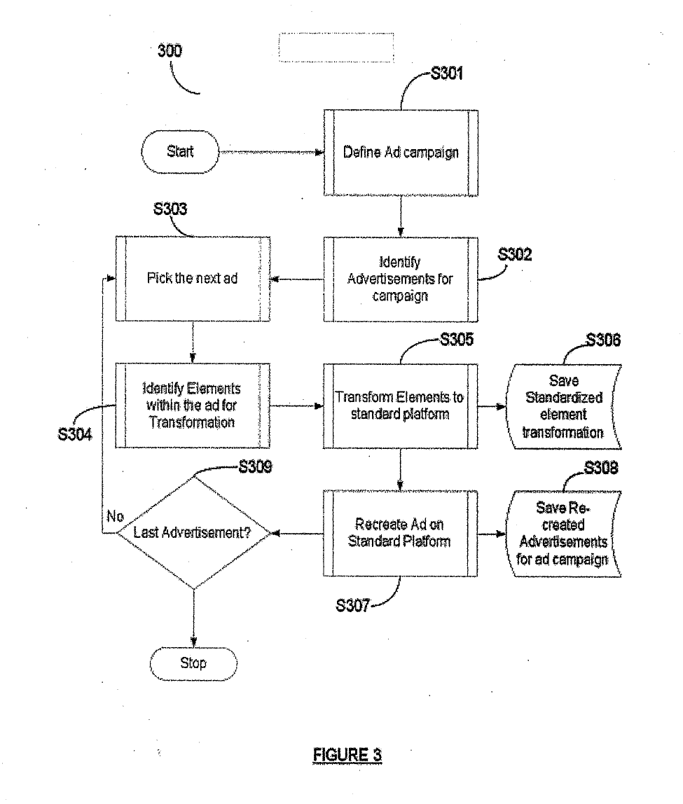

FIG. 3 is a flowchart 300 showing transformation from externally developed ads 101,102, and 103 to the reference screen of the SADP 201 (FIG. 2). An embodiment of the invention includes the following steps:
Defining an ad campaign (S301);
Developing ads, 101 102, and 103 that are acceptable for the campaign using available ad development tools (S302);
Picking the first ad 101 and identifying the various elements 121a, 122a, and 123a of the ad (S303);
Identifying all of the elements and objects of the ad selected and defining their characteristics to be transformed (S304);
Transforming each of the elements of the ad 101, i.e. 121a, 122a, and 123a with the necessary characteristics to the reference display format for displaying correctly on the reference display of the SADP platform 201 (S305);
Storing the transformed elements 121x, 122x, and 123x in a storage memory 230 (S306);
Reconstituting the selected ad 101 with all of the chosen elements 121x, 122x, and 123x to display the ad on the reference screen (S307);
Storing the re-constituted ads 101, 102, and 103 with the transformed elements 121x, 122x, and 123x in an ad storage memory 240 for transformation to the respective MHDs (S308); and
Checking to see if all the ads 101, 102, and 103 developed for the campaign have been transformed to the reference display format and, if not, continuing the process with the next ad, until all ads have been transformed and stored in the temporary ad storage memory (S309).

The total number of transformations necessary to convert the three ads, ad 101 with its three elements 121a, 122a, and 123a, ad 102 with its elements 121b, 122b, and 123b; and ad 103 with its elements 121c 122c, and 123c to the reference screen on the SADP 201 is the number of ads (N)×the number of elements per ad (P)=3×3=9 transforms.

The second level of transformation by the system shown in FIG. 2 is that of transforming the ads 101, 102, 103, already transformed for display on the reference display to the individual MHDs 111, 112, 113, 114, and 115. All the elements of the ads 121x, 122x, and 123x are already converted to the reference display of the SADP 201. The selected ads 101, 102, 103 with the transformed elements, 121x, 122x, and 123x are available from the ad memory 240. All the element transforms from the reference display screen of the SADP 201 to each of the MHDs 111, 112, 113, 114, and 115 are predefined and stored in memory 250. This allows the ads 101, 102, and 103, with their respective elements 121x, 122x, and 123x to be transformed in one step from the reference screen of the standardized ad development platform 201 to each MHD 111, 112, 113, 114, and 115, using the stored element transforms in the memory 250.

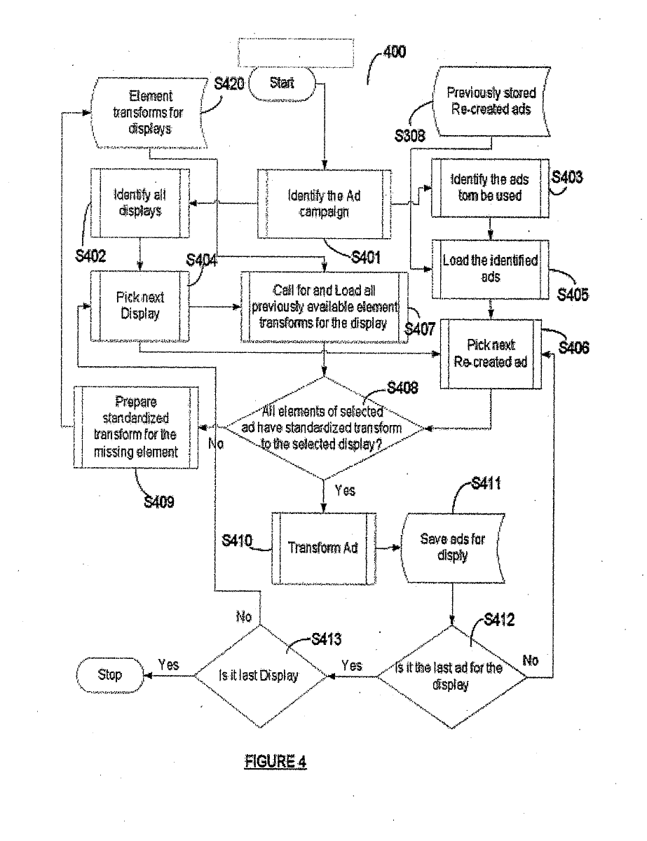

FIG. 4 is a flowchart 400 showing the transformation from the reference screen of the SADP 201 to the display screens of the individual MHDs 111, 112, 113, 114, and 115. An embodiment of the invention includes the following steps:
Identifying the ad campaign for which the ads have to be transformed (S401);
Identifying all of the MHDs, 111, 112, 113, 114 and 115 for the ad campaign (S402);
Identifying the ads 101, 102, and 103 to be used in the ad campaign from ads previously stored in the storage 240 at step S380 of FIG. 3 (S403);
Preloading the storage memory 250 with available predefined transforms for ad elements (S420);
Picking the MHD 111 for the initial transfer (S404);
Loading the identified ads into the system for transformation (S405);
Picking the ad 101 to be transformed to the MHD 111 (S406);
Loading all the available predefined transforms for elements from storage 250 (S407);
Checking if all the elements 121x, 122x, and 123x of the selected ad 101 has predefined standardized transforms to the selected MHD 111 (S408); if not then {continue}; else {go to step S412};
Generating any unavailable standardized transforms for elements needed for the selected ad 101 for transforming to the selected MHD 111 (S409);
Saving the generated standardized transform for future use in memory 250 (S420);
Transforming the selected ad 101 (all elements with their characteristics) of the selected ad 101 to the selected MHD 111 in one step (S410);
Saving the transformed ad for transfer to the MHDs (S411);
Checking if the there are any additional ads 102 and 103 to be transformed and, if so, initiating repeating of the steps S406 onward of transformation (S412); if none, then {continue};
Checking if there are any additional selected displays 112, 113, 114, and 115 to which ads have to be transformed and, if so, initiating repeating steps S404 onward for the other displays (S413); if none, then {continue}; and
Stopping the process of ad transformation.

The number of transformations from the reference screen of the standardized ad development platform 201 to the five MHDs 111, 112,113, 114, and 115, if all element transforms are pre-defined, is ads (N)×MHDs (M)=3×5=15

Hence, the total transforms needed=N×(P+M)=3×(3+5)=24

A few development platforms of commercial use can be standardized for development by converting the elements to the reference display of the SADP. Using an ad level transform with pre-developed and stored elements can be considered for further reduction in effort. In fact, such a transform allows the ad to be displayed correctly on the display of the SADP.

One long-term solution is to provide the standardized ad development platform to the developers. Here, the preference screen of the standardized ad development platform is the initial ad display platform with predefined element transforms used for the ad development. If an ad is originally generated on the standardized ad development platform for display on the reference screen, the effort needed for the transformation is much lower than if the development of the ad is done on non-standard plat forms. The total number of transforms needed in this case is the ads (N)×the number of MHDs (M)=3×5=15.

These effort reduction capabilities and other modifications to the ad transformation to MHDs by the standardization processes, though not described in detail, are within the scope of the invention disclosed herein.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. An apparatus for transforming advertisements (ads) for display on a plurality of different mobile handheld device (MHD) displays, comprising:
an interface configured to receive a plurality of ads, each ad having a plurality of ad elements;
a definition file stored in a system memory, said definition file comprising information with regard to a plurality of MHD displays;
a standardized ad development platform (SADP) configured to define a reference display format for display of said ads;
a control unit configured to transform one or more ads and associated ad elements into said reference display format and to recompile said one or more ads for said reference display;
a storage medium configured to store said one or more recompiled ads and associated plurality of elements; and
said control unit configured to transform each of said one or more recompiled ads into a plurality of transformed ads, each transformed ad formatted for display on a different MHD display;
wherein said control unit transforms a plurality of ads for proper display on a plurality of MHD displays without conversion of each of said plurality of elements of each of said plurality of ads; and wherein said control unit uses an intermediate transformation of said plurality of ads to said SADP reference display to recompile said plurality of ads to each of said different MHD displays.

2. An apparatus, comprising:
a plurality of advertisement development systems configured to development of a plurality of advertisements (ads), each ad comprising a plurality of elements;
a plurality of mobile handheld devices (MHDs);
a standardized ad development platform (SADP) configured to define a reference display format for display of said ads;
a temporary storage memory configured to store said plurality of elements of each said plurality of ads, said plurality of elements being transformed to said reference display format prior to compilation to each of said plurality of ads for display in said reference display format;
a first storage memory configured to store said plurality of ads as re- compiled with said transformed said plurality of elements for display on said reference display in said SADP; and
a second storage memory configured to store standardized transforms of said plurality of elements for display on said reference display from said standardized ad development platform to each said multiplicity of MHDs;
wherein said plurality of ads, each having said plurality of elements, is transformed for correct display on said plurality of MHDs by said intermediate step of transforming said plurality of ads to said reference display format.

3. A computer implemented method, comprising the steps of:
identifying all characteristics of mobile handheld device (MHDs) displays on which advertisements (ads) are to be displayed;
developing a plurality of ads on an advertisement platform;
identifying elements and objects of said plurality of ads for transformation;
transforming said elements and objects of said plurality of ads for correct display on a reference display of a standardized ad development platform (SADP);
developing standard transforms of all possible elements and objects of said plurality of ads for transformation of said plurality of ads between said reference display of said SADP and said displays of said MHDs, consistent with all of said characteristics of said MHD displays; and
storing said standard transforms for use with future developed ads; and
using said stored standard transforms to transform said plurality of ads for correct display on each of said displays of said MHDs;
wherein new ads are transferred for display on said reference display of said SADP as an intermediate step; and
wherein said ads are transferred from said reference display of said SADP using said stored said standard transforms for correct display on each of said display screens of said MHDs

4. An apparatus, comprising:
a standardized advertisement development platform (SADP) configured for development of a plurality of advertisements (ads), each ad comprising a plurality of elements and objects;
a reference display format in said SADP for display of said ads;
a plurality of mobile handheld devices (MHDs) with displays; and
a memory configured to store standardized transforms of said plurality of elements and objects that display correctly in said reference display format in said SADP for transformation of said plurality of elements and objects for correct display on each of said plurality of MHD displays;
wherein a plurality of ads, each ad having said plurality of elements and objects, each ad being developed using said SADP, and ad being correctly displayable in said reference display format of said SADP, are transformed for correct display on said plurality of MHDs in a single transformation step by use of said stored standardized transforms of elements.

5. A method, comprising the steps of:
using a standardized advertisement development platform to develop a plurality of advertisements (ads), each ad comprising a plurality of elements and objects;
identifying all mobile handheld device (MHD) displays for display of said plurality of ads;
developing and storing standardized transforms for transfer and display of said ads on said MHD displays, said transforms developed and stored for all elements and objects that can be used in development of said plurality of ads; and
using said stored standardized transforms to transform and display said plurality ads on said MHDs displays;
wherein all characteristics of all elements and objects of said plurality of ads are transformed for correct display on said plurality of MHD displays.
